(19) United States
(12) Patent Application Publication
(10) Pub. No.: US 2017/0003959 A1
(43) Pub. Date: Jan. 5, 2017

(54) DETECTION OF APPLICATION TOPOLOGY CHANGES

(71) Applicant: CA, Inc., New York, NY (US)

(72) Inventors: Erhan Giral, Daly City, CA (US); Tomas Kolda, Prague (CZ)

(21) Appl. No.: 14/755,179

(22) Filed: Jun. 30, 2015

(51) Int. Cl. G06F 9/44

(52) U.S. Cl. CPC G06F 8/75

(57) ABSTRACT

Changes in application topology can be determined, stored, analyzed and presented for evaluation as event journals. The information about inter-component calls can be recorded at multiple time instances, and then the component call information can be aggregated in different ranges or windows of time. Each aggregation of component call information can be used to determine different states of application topology, and the different states can be analyzed to determine changes between the application topology states and their relationship with performance degradations.

### BACKGROUND

The disclosure generally relates to the field of data processing, and more particularly to application topology.

An application (i.e., one or more machine-readable programs) often includes a large number of application components that are identified with different monikers depending upon the programming language, host platform, etc. Examples of monikers for software components include procedure, function, method, and routine. An application component can call another application component that is external to the application that includes the calling application component. For instance, a web service component of a first application can call an authentication component of another application. The authentication component of the second application may access a database before responding to the calling component in the first application. The authentication component may also call another third party authentication component for a Turing test. The complexity of interactions among components across applications can increase very quickly.

### SUMMARY

Changes in application topology can be determined and presented for correlation against performance events or metrics over a time period. The information about inter-component calls can be recorded at multiple time instances, and then the component call information can be aggregated in different ranges or windows of time. Each aggregation of component call information can be used to determine different states of application topology, and the resulting different states can be analyzed to determine changes between the application topology states. With temporal information for the application topology state changes, the application topology state changes can be evaluated against performance metrics or performance events at corresponding times to identify the performance impact of the topological changes.

This summary is a brief summary for the disclosure, and not a comprehensive summary. The purpose of this brief summary is to provide a compact explanation as a preview to the disclosure. This brief summary does not capture the entire disclosure or all embodiments, and should not be used to limit claim scope.

### BRIEF DESCRIPTION OF THE DRAWINGS

Embodiments of the disclosure may be better understood by referencing the accompanying drawings.

FIG. 1 depicts a conceptual diagram of recording component call information and generating a visual representation of application topology changes between two different time windows with the recorded information.

FIG. 2 depicts an example portion of the component call repository 105.

FIG. 3 depicts a flowchart of example operations for an agent to filter and record component call information.

FIG. 4 depicts a flowchart of example operations for determining application topology changes between different application topology states.

FIG. 5 depicts a flowchart of example operations for determining application topology changes based on a start time and end time input.

FIG. 6 depicts a flowchart of example operations for determining application topology changes based on input parameters that include a start time, window size, window slide, and a number of topology states.

FIG. 7 depicts an example computer system with an application topology change analyzer.

### DESCRIPTION

The description that follows includes example systems, methods, techniques, and program flows that embody embodiments of the disclosure. However, it is understood that this disclosure may be practiced without these specific details. In other instances, well-known instruction instances, protocols, structures and techniques have not been shown in detail in order not to obfuscate the description.

Overview

Application topology refers to a conceptual arrangement of application components (also referred to herein as “components”) and the “connections” among them. A connection between components, components A and B for example, refers to component A invoking or calling component B. An application can be instrumented with code (referred to as “probes”) to determine when the calls between components are made. The probes supply information about the calls to an agent associated with the instrumented application (e.g., program code embedded within the application, program code injected into the application, a background process, or a daemon). The agent can then supply the information from the probes for visualization of the application topology. For example, the application topology can be depicted in some form of a directed graph, with directional indicators to show the call dependencies. Application topology is dynamic over time with any number of calls being made between components. A depiction of application topology captures a single state of the application topology for a given time window.

Changes in application topology can be determined and presented for correlation against performance events or metrics over a time period. The information about inter-component calls can be recorded at multiple time instances, and then the component call information can be aggregated in different ranges or windows of time. Each aggregation of component call information can be used to determine different states of application topology, and the different states can be analyzed to determine changes between the application topology states. With temporal information for the application topology changes, the application topology changes can be evaluated against performance metrics or performance events at corresponding times.

Example Illustrations

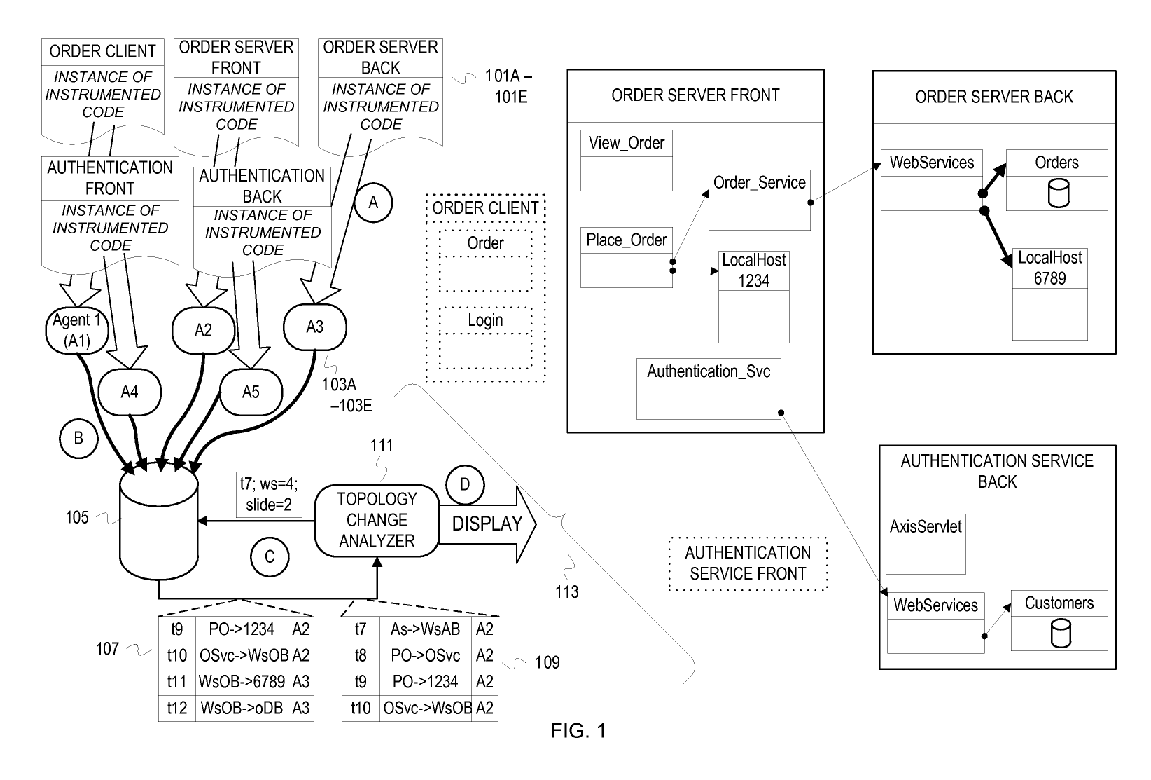

FIG. 1 depicts a conceptual diagram of recording component call information and generating a visual representation of application topology changes between two different time windows with the recorded information. FIG. 1 depicts instances of five different instrumented program codes that relate to trading assets.

The five program codes have been instrumented with probes that supply information about calls between application components. The instances include instrumented program instances 101A-101E. The instrumented program instance 101A is an instance of an instrumented program “ORDER CLIENT,” which corresponds to a client side program. The instrumented program instance 101B is an instance of an instrumented program “ORDER SERVER FRONT,” which corresponds to a client facing (i.e., front end) server program. The instrumented program instance 101 C is an instance of an instrumented program “ORDER SERVER BACK,” which corresponds to a server program that is not client facing. The instrumented program instance 101D is an instance of an instrumented program “AUTHENTICATION FRONT,” which corresponds to a front end authentication server program. The instrumented program instance 101E is an instance of an instrumented program “AUTHENTICATION BACK,” which corresponds an authentication server program that is not client facing.

In this example illustration, each of the instances is associated with a different agent. The agents are agents 103A-103E. The associations between program instances and agents are as follows: the instrumented program instance 101A and the agent A1 103A; the instrumented program instance 101B and the agent A2 103B; the instrumented program instance 101C and the agent A3 103C; the instrumented program instance 101D and the agent A4 103D; and the instrumented program instance 101E and the agent A5 103E.

FIG. 1 is annotated with a series of letters A-D. These stages A-D represent stages of operations. Each of the stages represents multiple operations performed by a machine with various timing. For instance, the operations represented by stages A and B can be ongoing with respect to stages C and D. The stages illustrate one example to aid in understanding this disclosure and should not be used to limit the claims. Subject matter falling within the scope of the claims can vary with respect to the order and some of the operations.

At stage A, the instrumented program instances 101A-101E supply information about component calls to associated agents. Probes in the instrumented program instance 101A supply information that identifies a time, calling component identifier, and callee component identifier. The probes supply this information to the associated agent A1 103A. Probes of the other instrumented program instances operate similarly, supplying time of calls, caller component identifiers, and callee component identifiers to the associated agent.

At stage B, the agents 103A-103E record selected information supplied from the probes into a component call repository 105. The agents 103A-103E record the selected information by time into the component call repository 105. The agents either attach an agent identifier to the information when recording or requesting recording of the information, or request an agent identifier to be associated with the selected information in the repository 105. Criteria for selecting information may have been communicated to the agents, and/or the agents may have been configured with the criteria. The criteria may specify that calls repeated within a specified time period are not to be recorded in the component call repository 105 to limit the monitoring overhead. The criteria may also specify types of caller and/or callee components of interest. The program instances 101A-101E may be instrumented to detect component calls between specified types or categories of components. For instance, information may be limited to cross boundary component calls. A boundary can correspond to the boundary of an application or the boundary of a program. For instance, a call from a client side program instance to a corresponding server side program instance can be considered a cross boundary component call. A call from a first application instance to another application instance hosted on a virtual machine may not be considered a cross boundary call, although the environment, administrator, etc. may lead to a different characterization.

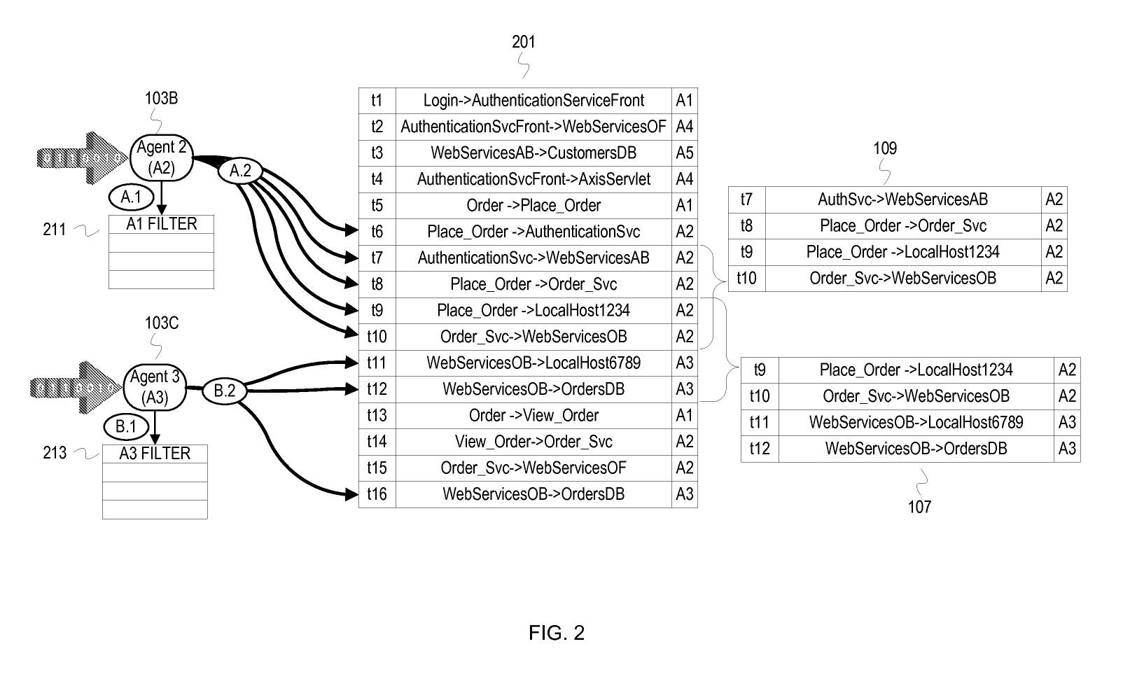

At stage C, a topology change analyzer 111 obtains component call information from the repository 105 for different time windows to display changes between application topology states. The topology change analyzer 111 creates a request or command to retrieve data from the repository 105. In this illustration, the topology change analyzer 111 specifies the access parameters as “t7; ws=4; slide=2.” These parameters indicate a beginning point for the data retrieval at time instant t7. The parameter “ws=4” indicates a window size of 4 (i.e., 4 component call entries or 4 time instants). The parameter “slide=2” indicates that the window should slide two entries. For further assistance in explaining the retrieval of data, FIG. 2 will be described.

FIG. 2 depicts an example portion of the component call repository 105. FIG. 2 also depicts some insertions of component call information and retrievals of component call information. The depicted information 201 includes 16 entries for 16 time instants at which a component call was made. The presentation of the information 201 as a table is merely for ease of explanation. A data structure or data structures used to implement the repository can vary (e.g., multi-dimensional array, linked list of entries in order of time instant, electronic messaging journal, relational database, etc.). In addition, the organization of information can vary. A repository can group information by agent, caller component, etc.

FIG. 2 depicts stages A.1, A.2, B.1, and B.2 that represent operations. The A stages indicate insertion of component call indications depending upon a filter 211 associated with the agent A2 103B. In stage A.1, the agent A2 103B determines whether a component call indication supplied by a probe in the instrumented program instance 101B should be filtered out. The agent A2 103B uses the filter 211 to determine whether to discard (or store elsewhere) a component call indication or to insert the component call indication into the repository 105. At stage A.2, the agent A2 103B inserts filtered component call indications into the repository portion 201. The agent A2 103B causes an indication of a component call made at time t6 to be written into the repository portion 201 (e.g., write request, database insertion request, etc.). The component call indication indicates that the component Place_Order (caller) of the ORDER SERVER FRONT program instance called a component AuthenticationService of the ORDER SERVER FRONT program instance. The agent A2 103B causes an indication of a component call made at time t7 to be written into the repository portion 201. This component call indication indicates that the component AuthenticationService of the ORDER SERVER FRONT program instance called WebServicesAB of the AUTHENTICATION SERVICE BACK program instance. The other depicted component call indications are in the table below with the first column indicating the time instance, the second column indicating the caller component and callee component, and the last column indicating the associated agent.

| | | |
|---|---|---|
| t8 | Place_Order −> Order_Svc | A2 |
| t9 | Place_Order −> LocalHost1234 | A2 |

The B stages indicate insertion of component call indications depending upon a filter 213 associated with the agent A3 103C. In stage B.1, the agent A3 103C determines whether a component call indication supplied by a probe in the instrumented program instance 101C should be filtered out. The agent A3 103C uses the filter 213 to determine whether to discard (or store elsewhere) a component call indication or to insert the component call indication into the repository 105. At stage B.2, the agent A3 103C inserts filtered component call indications into the repository portion 201. The inserted component call indications are indicated in the table below. The agents 103B-103B filter the component call indications in accordance with the previously mentioned selection criteria when describing stage B of FIG. 1. In the table below, the component call indications at time t12 and time t16 are the same. This indicates that the threshold for limiting repeat component calls in the repository 105 is less than the time between t12 and t16 and/or an aspect of the component call is an exception to the time threshold.

| | | |
|---|---|---|
| t11 | WebServicesOB −> LocalHost6789 | A3 |
| t12 | WebServicesOB −> OrdersDB | A3 |
| t16 | WebServicesOB −> OrdersDB | A3 |

To the right of the repository portion 201, FIG. 2 depicts the data retrieved from the repository 105 in accordance with the access parameters from the topology change analyzer 111. Since the access parameters indicated a starting time instant of t7, a component call indication entry corresponding to time t7 is retrieved. The window size was specified as 4, so the subsequent three entries are also retrieved. The component call indications 109 from t7-t10 will be used to generate a first application topology state. In other words, the retrieved data represents the state of the application topology from t7 to t10. With the slide parameter set to 2, the first entry for the next application topology state is t9. And with a window size of 4, the entries 107 for time instants t9-t12 are retrieved for a second application topology state.

Returning to FIG. 1, the topology change analyzer 111 obtains the component call indication entries 109 and the component call entries 107. Due to space constraints, the names of the caller components and callee components have been abbreviated in FIG. 1. At stage D, the topology change analyzer 111 determines changes between topology states of the obtained component call indication entries and displays indications of the changes. The topology change analyzer 111 generates a first topology state representation based on the entries 109, and a second topology state representation based on the entries 107. The topology change analyzer 111 then determines differences between the two state representations. The differences indicate changes from a first topology state corresponding to t7-10 and a second topology state corresponding to t9-t12. The topology change analyzer presents this information via a graphical user interface in FIG. 1.

Presentation of application topology changes can take many forms depending on user interface decisions, screen size, mode of perception (e.g., visual, tactile, etc.). The graphical depiction in FIG. 1 use directed arrows to depict call dependencies. The bolder arrows indicate changes between the application topology states. This example illustration shows a change in topology based on two calls from the WebServices component of the ORDER SERVER BACK program instance. A performance event or performance metric corresponding to the time instants t11 and t12 can be correlated with these calls. This example also illustrates depiction of all of the components of the program instances with component call indications in the repository 105. However, those program instances and their components that do not make calls during the time windows of interest are depicted with dotted boundaries. The dotted boundaries are just one example of how to depict the entire topology of components while deemphasizing those components without calls within the time windows of interest. Components that fall outside of the time windows of interest could have been determined beforehand. For instance, the topology change evaluator can maintain a history of applications and application components to depict those that are active during a time window and those that are inactive during a time window.

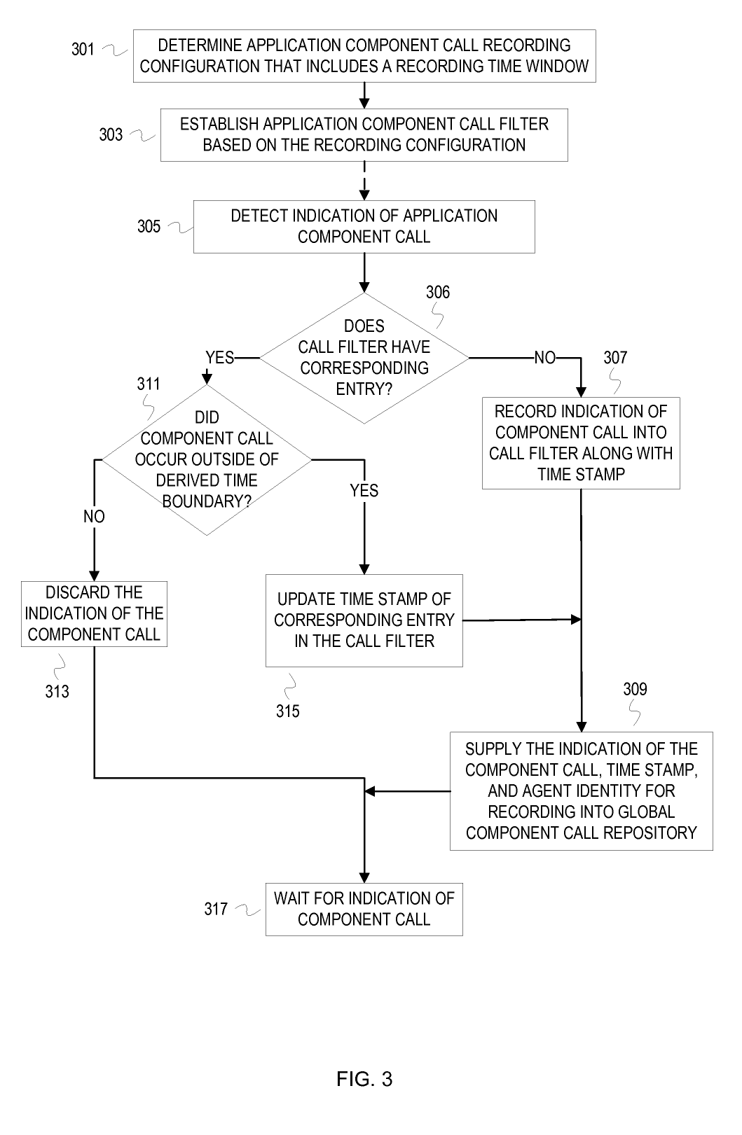

As previously mentioned, the agents can filter or select component call indications for recording into a repository in accordance with specified criteria. FIG. 3 depicts a flowchart of example operations for an agent to filter and record component call information. FIG. 3 refers to an agent performing the operations.

An agent determines an application component call recording configuration that includes a recording time window (301). The agent can read the configuration information from a file, receive the configuration information via an inter-process message, receive a network message that carries the configuration information, etc. The configuration information at least indicates a recording time window. The recording time window specifies a time threshold for filtering component call indications. For instance, the recording time window may be 5 seconds. Thus, the agent will not record component call indications that are the same within a 5 second window. In some cases, the recording time window can be applied to similar component calls. Similarity can be defined by types of components involved in a component call. For instance, the agent may limit recording of component call indications with a caller component that is a database to 1 within the recording time window. Moreover, the configuration information may not specify a recording time window. But the configuration information may specify a window size for a topology state. The agent can derive a time boundary for repeat or similar component call indications from the topology state window size. For instance, the agent may set the time boundary for repeats or similar component calls to half the topology state window size.

After determining the configuration information, the agent establishes an application component call filter based on the configuration information (303). To establish the filter, the agent can obtain memory for recording component call indications (“component call cache”). The size of the component call cache can be based on amount of space to host a component call indication and a time threshold (e.g., the recording time window or a time boundary derived from a topology state window size). The agent can also indicate in the filter types of caller and/or callee components to disregard for recording.

After establishing the filter, the agent runs (e.g., in the background) and waits for component call indications from probes. When the agent detects an indication of an application component call (305), the agent determines whether the filter has a corresponding entry (306). The agent may detect application component call indications with an interrupt mechanism, by monitoring a queue, via a socket or port, etc. The agent can compare each attribute of a component call indication (time instant, caller identifier, callee identifier) to determine whether a filter entry corresponds to the detected component call indication. The agent can determine a filter entry corresponds with a single attribute, such as caller identifier.

If the filter has an entry with a matching component call indication, then the agent determines if the detected component call indication occurs outside of a time boundary (311). The time boundary may be the time window indicated in the configuration or derived from the time window indicated in the configuration.

If the indicated component call occurred outside of the time boundary (311), then the agent updates the time stamp of the corresponding entry in the filter (315). The agent compares the time stamp of the matching filter entry to the time stamp of the indicated component call to determine whether indicated component call occurred outside of the time boundary.

If the indicated component call did not occur outside of the time boundary (311), then the agent discards the component call indication (313). A repeated component call within the time boundary may not provide useful information with respect to application topology changes. In some cases, this information may be helpful though. Embodiments can update a counter for the repeat entry in the component call repository. The counter can be used to depict high frequency component calls.

If the filter did not have a corresponding entry (306), then the agent records an indication of the component call and a time stamp of the component call into the filter (307). The agent continues updating the filter or component call cache and can maintain the filter according to an appropriate caching technique. The agent can evict least frequently indicated component calls, evict oldest entries, etc.

After updating the filter (307) or after updating a time stamp of a filter entry (315), the agent supplies the indication of the component call, time stamp, and an identifier of the agent for recording into a global component call repository (309). The repository is referred to as a global repository because it can host component call indications from multiple applications running across a system (e.g., enterprise system) to provide a global view of the application topology for the system.

After processing a component call indication, the agent waits for another indication of a component call or begins processing another already detected one (317). For instance, the agent may traverse a queue of component call indications or return to an idle state if none are available for processing.

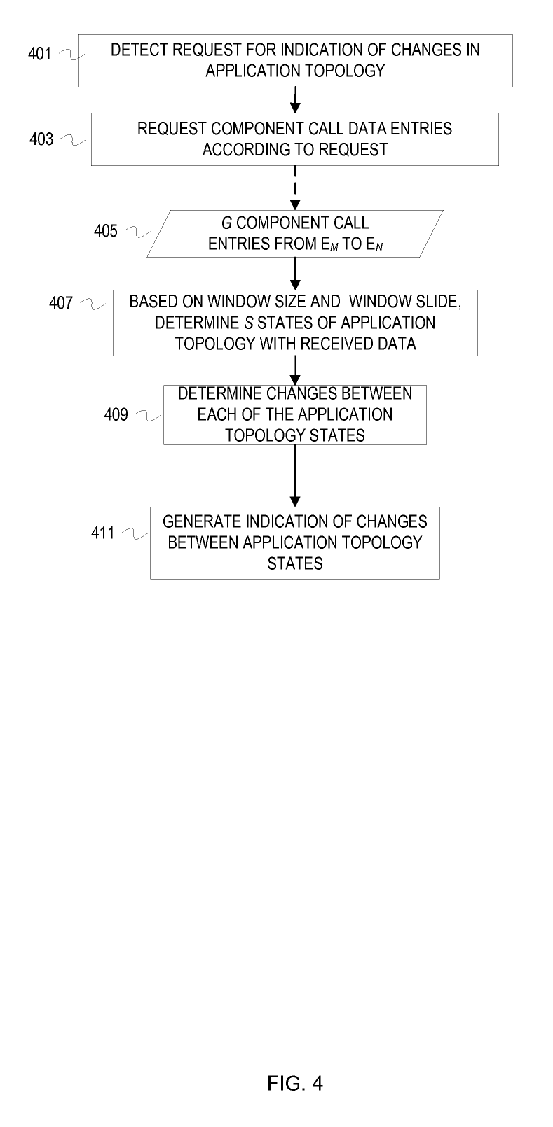

With a populated repository of application component calls, changes in application topology can be determined. FIG. 4 depicts a flowchart of example operations for determining application topology changes between different application topology states. FIG. 4 refers to a topology analyzer (an abbreviated version of topology change analyzer) as performing the operations.

A topology analyzer detects a request for indication of changes in application topology (401). The topology analyzer can detect the request as input from a user interface, parameters read from a file, parameters indicated in an application or network message, etc. The request indicates parameters for retrieval of component call entries from a component call repository. The parameters can be a start time and/or an end time. The parameters can be a start time and a window size. Some parameters for data retrieval can be default parameters or can be specified in a request. Examples of parameters that can be default parameters or specified include a window slide and a window size.

The topology analyzer generates a request or command to retrieve component call data entries according to the request parameters (403). The topology analyzer can create a database command or read request based on the request parameters.

In response to the request or command, the topology analyzer receives G component call data entries E_{M} to E_{N} (405). The variable G represents the total number of data entries provided to the topology analyzer. E_{M} represents the Mth entry and E_{N}represents the Nth entry. These entries fall within a time range defined by the start time parameter and the window size parameter, which may be a default parameter. For instance, the entry E_{M} may be the first entry with a time stamp after the time start parameter.

With the component call data entries, the topology analyzer determines S states of application topology based on a window size and window slide (407). The topology analyzer generates a representation of a topology state from entries that fall into the window size, starting from entry E_{M}. For instance, the topology analyzer can generate data that represents a directed graph based on the entries within a first window. The topology analyzer slides the window over a number of entries equal to the window slide and generates a representation of topology state from the entries that fall into that window. For instance, the topology analyzer can generate data that represents a directed graph based on the entries within a first window. The topology analyzer can generate data that represents a directed graph for each successive window of component call data entries. Each directed edge can represent a component call and the connected nodes correspond to the caller component and callee component.

After generating the topology states (407), the topology analyzer determines changes between each of the topology states (409). With the directed graphs as an example, the topology analyzer can compare each successive pair of directed graphs and determine new edges and/or missing edges that occur in the directed graph of the later topology state.

After determining the topology changes, the topology analyzer can indicate the determined topology changes (411). Indicating the topology changes can take many forms depending on design of the topology analyzer, consumer of the indicated changes, etc. For instance, the topology analyzer can indicate changes by marking edges that occur after topology state transitions and/or edges that no longer occur after topology state transitions. The topology analyzer could generate a list of component calls that occur after topology state transitions. Moreover, the depiction of changes can take many forms. New component calls can be depicted with various graphical manipulations. Component calls that fall outside of a topology state after a state transition can be depicted with a faded or deemphasizing graphical manipulation. A chain of component calls that connect to a new component call in a final topology state can be depicted with gradient effects. Finally, changes can be indicated for other senses besides vision or in combination with vision (e.g., tactile, aural) and accommodating different sensory capabilities (e.g., color blindness).

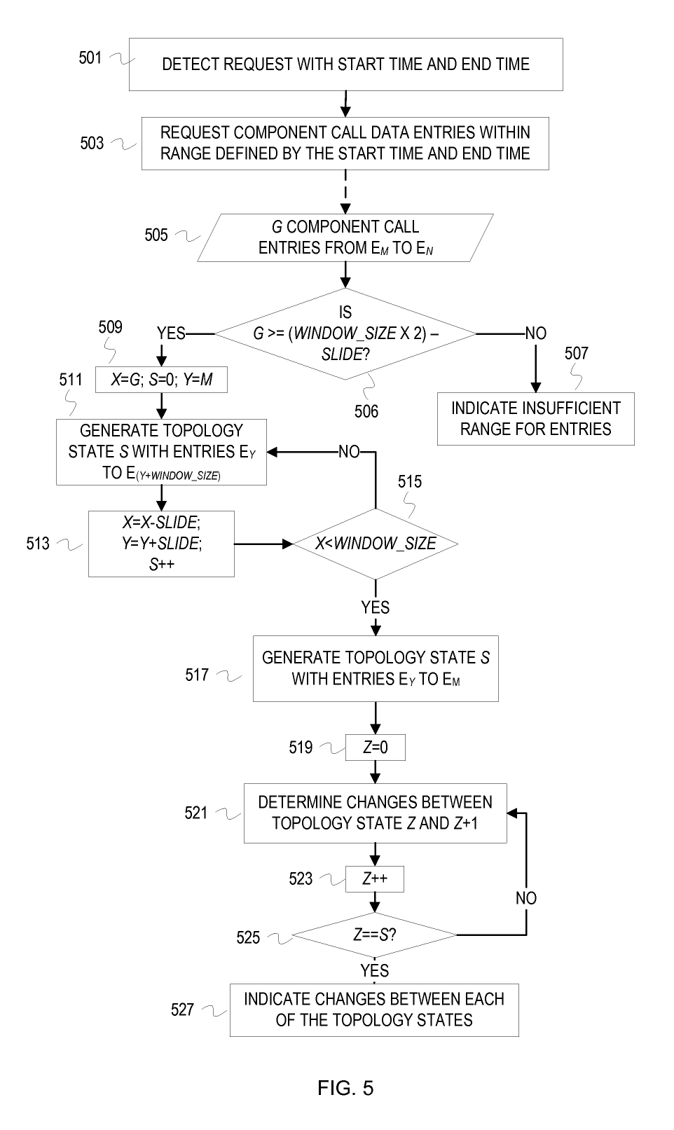

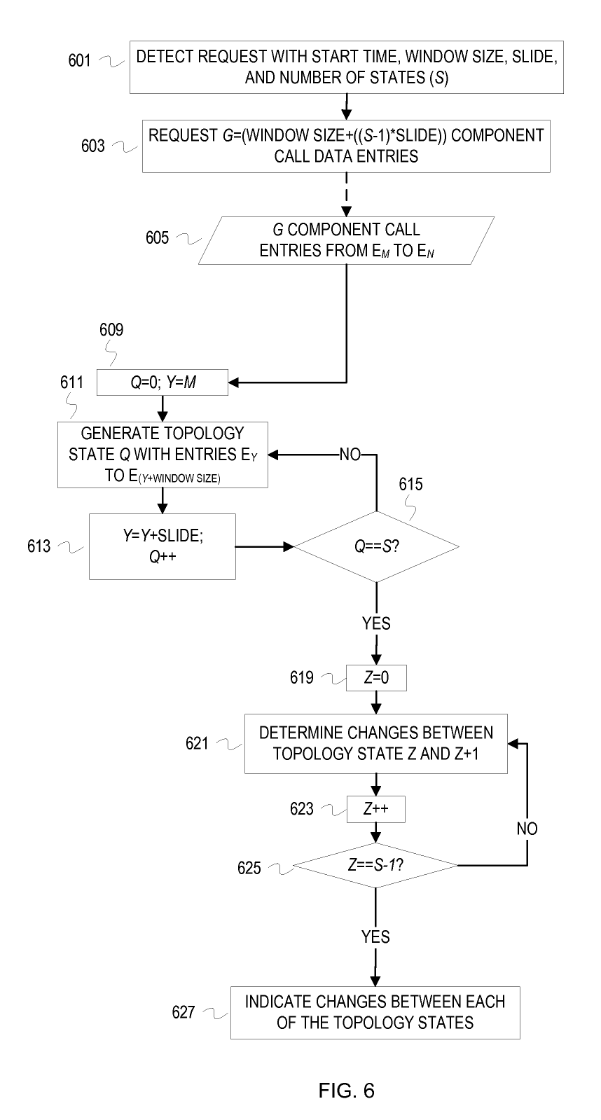

In addition to the different techniques for indicating application topology changes and presenting those indications of changes, determining changes can be accomplished differently. FIGS. 5-6 depict flowcharts of example operations for determining application topology changes in response to different input parameters.

FIG. 5 depicts a flowchart of example operations for determining application topology changes based on a start time and end time input. FIG. 5 refers to a topology analyzer performing the operations.

A topology analyzer detects a request for indication of application topology changes (501). The request indicates a start time and an end time for the topology analyzer to retrieve component call data and ascertain application topology states within the range defined by the start time and end time.

The topology analyzer requests component call data entries within the range defined by the start time and end time (503). In addition to indication of the start and end times, the topology analyzer can specify margins. Since the start times and end times may not have matching time instants in a component call repository, the topology analyzer can specify a margin of variance for searching the repository.

After submitting the request, the topology analyzer receives corresponding component call data entries 505. The corresponding component call data entries include G component call data entries E_{M} to E_{N}. The variable G represents the total number of data entries provided to the topology analyzer. E_{M} represents the Mth entry and E_{N}represents the Nth entry. These entries fall within a time range defined by the start time and the end time.

The topology analyzer determines whether the total number of returned entries is greater than or equal to minimum number of data entries for an analysis (506). The minimum number of data entries can be determined with window size and window slide (“slide”). The minimum number of entries is double the window size minus the slide. This minimum number of data entries allow for at least two topology states based on component call data entries that satisfy the window size and with a window that slides by the slide amount. The minimum number of data entries can change with a minimum number of topology states.

If the minimum number of data entries is not retrieved (506), then the topology analyzer indicates that the range defined by the start time and end time is insufficient (507). The topology analyzer can record this indication in a log or generation a notification for presentation via a user interface. Embodiments can also adjust the time range to satisfy this minimum number of data entries.

If the minimum number of data entries is retrieved (506), then the topology analyzer initializes variables (509). The topology analyzer initializes variables used to move the window through the component call data entries (variable Y), to track progress of the window through the component call data entries (variable X), and to determine a number of topology states that can be generated from the retrieved component call data entries (variable S). The variable X is initialized to G. The variable S is initialized to 0. The variable Y is initialized to M, which is the index value for the earliest or first retrieved component call data entry.

After variable initialization, the topology analyzer generates a topology state S with component call data entries E_{Y} to E_{(Y+WINDOW SIZE)} (511). The topology analyzer creates a data representation of the topology state S with these entries that are within the current window. The topology analyzer, for instance, generates data that represents graph nodes for each of the caller components and each of the callee components in the current window of component call data entries. The topology analyzer then generates data that represents a directed edge from each caller node to the corresponding callee node.

After generating the topology state based on the current window of component call data entries, the topology analyzer updates the variables that move the window and track progress of the window (X and Y) and track the states (S) (513). The topology analyzer decreases X by the slide and increases Y by the slide. The topology analyzer also increments S.

The topology analyzer then determines whether the window has moved through all of the component call data entries (515). For instance, the topology analyzer determines whether X exceeds the window size. If the window has not moved through all of the component call data entries, then the topology analyzer generates the next topology state (511). Otherwise, the topology analyzer generates the last topology state (517). The topology analyzer generates a topology state S with component call data entries E_{Y} to E_{M} (511).

After generating the last topology state, the topology analyzer initializes a control variable Z (519). The topology analyzer uses the control variable Z to iterate through comparisons of the generated topology states. The topology analyzer initializes Z to 0.

The topology analyzer determines changes between topology states (521). The topology analyzer determines changes between topology states Z and Z+1. The topology analyzer progresses through pairs of topology states in chronological order. After the comparison, the topology analyzer increments the control variable Z (523).

After incrementing the control variable Z, the topology analyzer determines whether all of the topology states have been analyzed. In this illustration, the topology analyzer determines whether the control variable Z is equal to the topology state counter S. If the topology analyzer determines that there are additional topology states to analyze, then the topology analyzer determines changes between the next pair of topology states (521). If the topology states have been analyzed, then the topology analyzer indicates the determined changes between application topology states (527).

FIG. 6 depicts a flowchart of example operations for determining application topology changes based on input parameters that include a start time, window size, window slide, and a number of topology states. FIG. 6 refers to a topology analyzer performing the operations.

A topology analyzer detects a request for indication of application topology changes (601). The request indicates a start time, window size (WINDOW_SIZE), window slide (SLIDE), and a number of topology states (S). The topology analyzer will retrieve component call data entries based on these parameters and ascertain application topology states with the retrieved component call data entries.

The topology analyzer requests G component call data entries with a beginning corresponding to the start time (603). The topology analyzer determines G from the window size, number of topology states, and the slide. G can be calculated as G=(WINDOW_SIZE+((S−1)*SLIDE)).

After submitting the request, the topology analyzer receives corresponding component call data entries 605. The corresponding component call data entries include G component call data entries E_{M} to E_{N}. E_{M} represents the Mth entry and E_{N} represents the Nth entry.

The topology analyzer initializes variables (609). The topology analyzer initializes variables used to move the window through the component call data entries (variable Y), and to track topology states that can be generated from the retrieved component call data entries (variable Q). The variable Q is initialized to 0. The variable Y is initialized to M, which is the index value for the earliest or first retrieved component call data entry.

After variable initialization, the topology analyzer generates a topology state Q with component call data entries E_{Y} to E_{(Y+WINDOW SIZE)} (611). The topology analyzer creates a data representation of the topology state Q with these entries that are within the current window. The topology analyzer, for instance, generates data that represents graph nodes for each of the caller components and each of the callee components in the current window of component call data entries. The topology analyzer then generates data that represents a directed edge from each caller node to the corresponding callee node.

After generating the topology state based on the current window of component call data entries, the topology analyzer updates the variables that move the window (Y) and track the states (Q) (613). The topology analyzer increases Y by SLIDE. The topology analyzer also increments Q.

The topology analyzer then determines whether the requested number of topology states have been generated (615). For instance, the topology analyzer determines whether Q equals the number of specified topology states S. If S topology states have not been generated, then the topology analyzer generates the next topology state (611).

After generating S topology states, the topology analyzer initializes a control variable Z (619). The topology analyzer uses the control variable Z to iterate through comparisons of the generated topology states. The topology analyzer initializes Z to 0.

The topology analyzer determines changes between topology states (621). The topology analyzer determines changes between topology states Z and Z+1. The topology analyzer progresses through pairs of topology states in chronological order. After the comparison, the topology analyzer increments the control variable Z (623).

After incrementing the control variable Z, the topology analyzer determines whether all of the topology states have been analyzed. In this illustration, the topology analyzer determines whether the control variable Z is equal to 1 less than the number of topology states S. If the topology analyzer determines that there are additional topology states to analyze, then the topology analyzer determines changes between the next pair of topology states (621). If the topology states have been analyzed, then the topology analyzer indicates the determined changes between application topology states (627).

Variations

The example illustrations depict an agent receiving component call information from a single instrumented program instance. This is not necessary. An agent can be associated with multiple instrumented program instances, and filter the information before recording into a repository. In addition, an agent may not filter the information. An agent may write the information to a specified destination. At the destination, the component call information can be refined or filtered before analysis for topology changes.

The examples often refer to an “analyzer.” The analyzer is a construct used to refer to implementation of functionality for determining application topology changes. This construct is utilized since numerous implementations are possible. An analyzer may be an engine, web service, a particular component or components of a machine (e.g., a particular circuit card enclosed in a housing with other circuit cards/boards), machine-executable program or programs, firmware, a circuit card with circuitry configured and programmed with firmware for determining application topology changes, etc. The term is used to efficiently explain content of the disclosure. Although the examples refer to operations being performed by an analyzer, program code that determines application topology changes can have any of a variety of names depending upon platform, developer, standards, programming language, etc.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, an agent could perform additional operations when a filter indicates types of components. Some of the filtering that can be done by the agent may depend upon the component call indication supplied from the probes. If types of components are not indicated in the component call indication, then the agent may not be able to apply that filter entry (306) or the agent may determine type based on component identifier. In addition, the example illustrations for determining application topology changes create start beginning at a start time (FIGS. 4-6). Embodiments, however, can work backwards from an end time (e.g., a current time).

It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

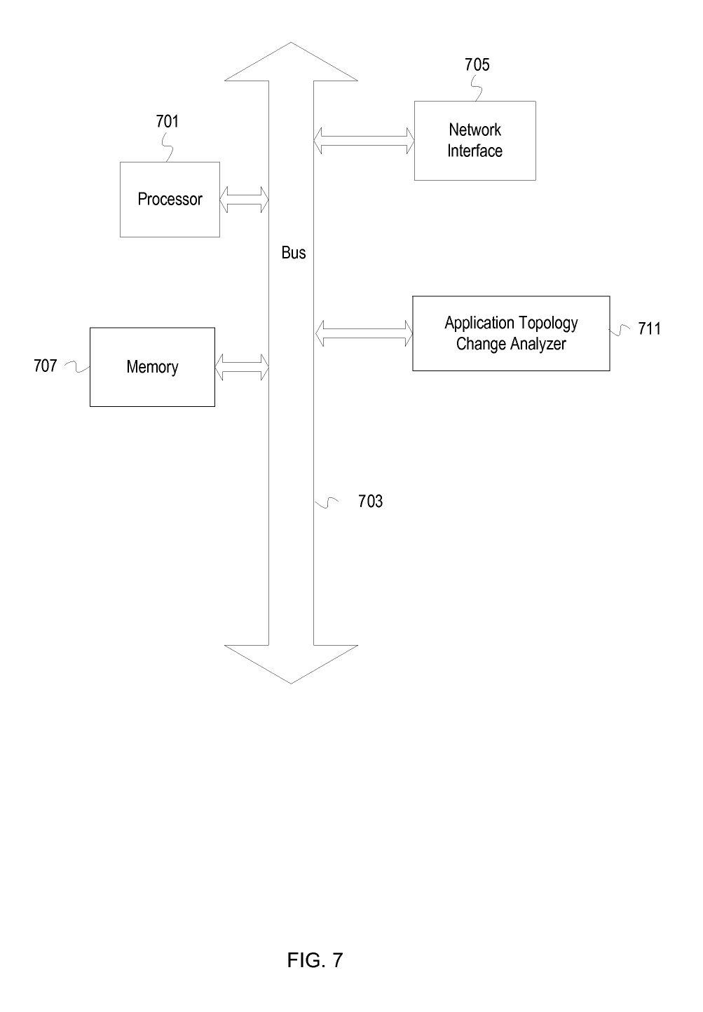

FIG. 7 depicts an example computer system with an application topology change analyzer. The computer system includes a processing unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes application topology change analyzer 711. The application topology change analyzer 711 determines multiple application topology states from component call information and determines changes between those states. Any one of the previously described functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The procesing unit 701 and the network interface 705 are coupled to the bus 703. Although illustrated as being coupled to the bus 703, the memory 707 may be coupled to the processing unit 701.

While the aspects of the disclosure are described with reference to various implementations and exploitations, it will be understood that these aspects are illustrative and that the scope of the claims is not limited to them. In general, techniques for determining application topology states and changes between the topology states as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

What is claimed is:

1. A method comprising:
determining a plurality of application topology states, each of the plurality of application topology states corresponding to a different time window;
determining changes between the plurality of application topology states in chronological order; and
indicating the changes between the plurality of application topology states.

2. The method of claim 1, wherein determining the plurality of application topology states comprises determining each of the plurality of application topology states with a different set of application component call data entries, wherein each application component call data entry indicates a time instant, a caller application component, and a callee application component, wherein the time instants indicated in each different set of application component call data entries are within a corresponding one of the different time windows.

3. The method of claim 2 further comprising:
determining a time instant for either a first or a last application component call data entry of a set of component call data entries;
determining a window size for a number of application component call data entries to determine an application topology state;
wherein a first set of application component data entries includes a first application component data entry corresponding to the time instant,
wherein each set of application component data entries includes a number of entries according to the window size.

4. The method of claim 2, wherein each component call data entry also indicates an agent associated with an application corresponding to at least one of the caller application component and the callee application component.

5. The method of claim 1, wherein each of the plurality of application topology states indicates calls between application components that occurred within the corresponding time window.

6. The method of claim 1, wherein determining the plurality of application topology states comprises generating a data representation of a directed graph for each of a plurality of sets of component call data entries, wherein each of the plurality of sets of component call data entries correspond to the different time window.

7. The method of claim 1, wherein determining the changes between the plurality of application topology states comprises determining application component calls indicated in a first of the plurality of application topology states but not indicated in a second of the plurality of application topology states, wherein the second application topology state corresponds to a second time window that is earlier than a first time window that corresponds to the first application topology state.

8. The method of claim 1 further comprising recording first indications of application component calls into a repository.

9. The method of claim 8 further comprising determining a filtering time window and filtering second indications of application component calls based, at least in part, on the filtering time window to yield the first indications.

10. The method of claim 9, wherein filtering based, at least in part, on the filtering time window comprises discarding repeat application component calls that occur within the time window.

11. The method of claim 1, wherein indicating the changes between the plurality of application topology states comprises supplying indications of the changes for graphical depiction.

12. A machine-readable storage medium having program code stored therein, the program code to:
obtain a plurality of sets of application component call indications with each set corresponding to a different time window, wherein each of the application component call indications indicates a time instant, a caller application component, and a callee application component;
for each set of the plurality of sets of application component call indications, generate a data representation of application topology state based, at least in part, on the set of application component call indications;
determine differences between the generated data representations of the application topology states in chronological order; and
indicate the determined differences.

13. An apparatus comprising:
a processing unit; and
a machine-readable medium having program code stored therein, the program code executable by the processor to cause the apparatus to,
determine a plurality of application topology states, each of the plurality of application topology states corresponding to a different time window;
determine changes between the plurality of application topology states in chronological order; and
indicate the changes between the plurality of application topology states.

14. The apparatus of claim 13, wherein the program code to determine the plurality of application topology states comprises program code to determine each of the plurality of application topology states with a different set of application component call data entries, wherein each application component call data entry indicates a time instant, a caller application component, and a callee application component, wherein the time instants indicated in each different set of application component call data entries are within a corresponding one of the different time windows.

15. The apparatus of claim 14, wherein the machine-readable medium further has stored therein program code executable by the processing unit to cause the apparatus to:
determine a time instant for either a first or a last application component call data entry of a set of component call data entries;
determine a window size for a number of application component call data entries to determine an application topology state;
wherein a first set of application component data entries includes a first application component data entry corresponding to the time instant,
wherein each set of application component data entries includes a number of entries according to the window size.

16. The apparatus of claim 14, wherein each component call data entry also indicates an agent associated with an application corresponding to at least one of the caller application component and the callee application component.

17. The apparatus of claim 13, wherein each of the plurality of application topology states indicates calls between application components that occurred within the corresponding time window.

18. The apparatus of claim 13, wherein the program code to determine the plurality of application topology states comprises program code to generate a data representation of a directed graph for each set of a plurality of sets of component call data entries, wherein each set of the plurality of sets of component call data entries corresponds to a different time window.

19. The apparatus of claim 13, wherein the program code to determine the changes between the plurality of application topology states comprises the program code to determine application component calls indicated in a first of the plurality of application topology states but not indicated in a second of the plurality of application topology states, wherein the second application topology state corresponds to a second time window that is earlier than a first time window that corresponds to the first application topology state.

20. The apparatus of claim 13, wherein the program code to indicate the changes between the plurality of application topology states comprises program code to supply indications of the changes for graphical depiction.
